(19) United States
(12) Patent Application Publication
(10) Pub. No.: US 2005/0044049 A1
(43) Pub. Date: Feb. 24, 2005

(54) License and privilege management method in digital contents sale

(76) Inventors: Nobuya Okayama, Kawasaki (JP); Hiroko Nakagawa, Tokyo (JP); Tatsuro Arai, Ebina (JP); Taketoshi Niinou, Tokyo (JP); Kenjiro Takagi, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/671,498

(22) Filed: Sep. 29, 2003

(30) Foreign Application Priority Data
Mar. 28, 2003 (JP) 2003-089681

(51) Int. Cl. G06F 17/60

(52) U.S. Cl. 705/59

(57) ABSTRACT

When digital contents sold to a user become useless to the user, the digital contents and the license of the digital contents are collected or purchased from the user so that a privilege such as discount sale of other digital contents or addition of discount points is granted to the user having the license.

### BACKGROUND OF THE INVENTION

1. Field of the Invention

The present invention relates to a system for collecting or purchasing unnecessary digital contents and licenses thereof from users.

2. Description of the Related Art

With the development of communications on the Internet, portable information terminals, etc., distribution and sale of digital contents using these terminals and networks have been activated. A technique for performing distribution and sale of digital contents has been described in JP-A-11-224288.

### SUMMARY OF THE INVENTION

In digital contents distributing business, there was however a problem that it was difficult to purchase or collect contents from users because the contents were not delivered through a general physical distribution system. Therefore, a method of collecting unnecessary digital contents from users to thereby make it easier for the users to purchase new digital contents has been demanded.

An object of the invention is to provide a digital contents management method in which unnecessary digital contents can be returned easily.

To achieve the foregoing object, in accordance with the invention, when a user issues a license return request to return a license granted for digital contents already purchased by the user, the license corresponding to the license return request is deleted; the user corresponding to the deleted license is specified; and management is made so that the specified user is associated with contents of the deleted license or with a privilege granted in accordance with the license return request.

### BRIEF DESCRIPTION OF THE DRAWINGS

FIG. 1 is a diagram showing the system configuration of a digital contents license and incentive point management system according to an embodiment of the invention;

FIG. 2 is a diagram showing the configuration of a digital contents management device 110;

FIG. 3 is a diagram showing the configuration of a license management device 120;

FIG. 4 is a diagram showing the configuration of a digital contents storage device 130;

FIG. 5 is a diagram showing the configuration of a digital contents synchronization device 140;

FIG. 6 is a diagram showing the configuration of a terminal unit 150;

FIG. 7 is a flow chart showing a processing procedure in a contents setup method;

FIG. 8 is a flow chart showing a processing procedure in a contents collection/purchase method;

FIG. 9 is a flow chart showing a processing procedure in an individual contents download method;

FIG. 10 is a flow chart showing a processing procedure in a batch contents download method;

FIG. 11 is a view showing a user-based license transfer management table for managing the number of licenses collected from each user, the number of licenses purchased from each user and the number of incentive points given to each user;

FIG. 12 is a view showing a transaction management table for managing processing concerning sale, collection and purchase of contents; and

FIG. 13 is a view showing a merchandise management table for indicating licenses and selling prices of contents.

### DETAILED DESCRIPTION OF THE INVENTION

A preferred embodiment of the invention will be described below in detail with reference to the drawings but the invention is not limited thereto.

A system for managing licenses of digital contents and privileges (e.g., points that can be used for purchase of digital contents) corresponding to return of licenses in digital contents sale where the licenses of the digital contents can be returned (specifically, collected or purchased) from users will be described as an embodiment of the invention. Digital contents may be hereinafter also referred to as contents.

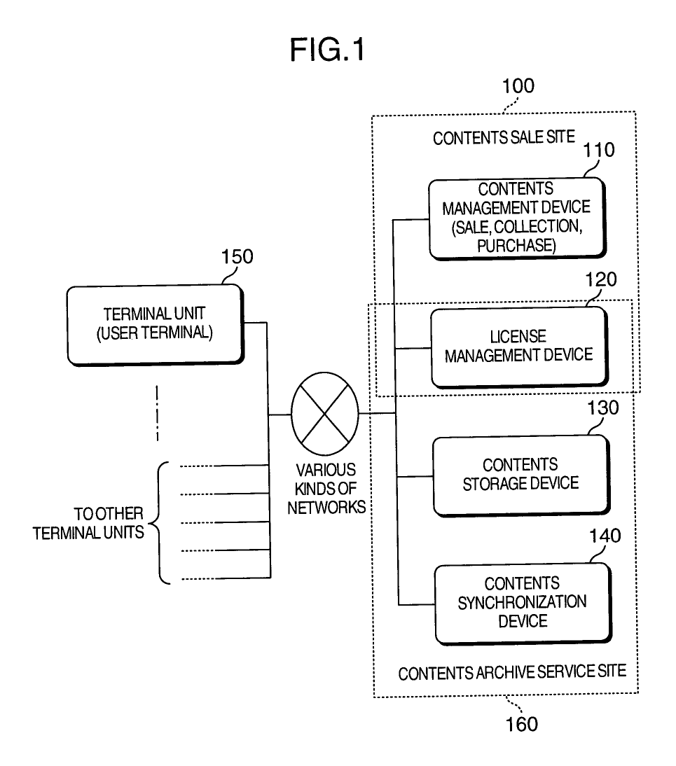

FIG. 1 is a diagram showing the schematic configuration of a digital contents license and incentive point management system according to this embodiment. As shown in FIG. 1, this system includes a contents management device 110, a license management device 120, a contents storage device 130, a contents synchronization device 140, and terminal units 150.

Although the license and incentive point management system includes the contents synchronization device 140 provided for the sake of user's convenience, each user can select contents one by one and download the contents one by one to the user's terminal unit not via the contents synchronization device 140. On the other hand, the user can make batch contents download via the contents synchronization device 140.

The contents management device 110 is provided for sale, collection and purchase of contents. The contents management device 110 manages contents received in trust from a contents holder or the like. The contents management device 110 performs a process for granting and regenerating licenses. Incidentally, license management is performed by the license management device 120.

The license management device 120 manages licenses generated when contents managed by the contents management device 110 are sold to users. Respective processing portions in the license management device 120 may be placed in the contents management device 110 and the contents storage device 130 for the sake of reduction in cost. The separate provision of the license management device 120 permits the license management device 120 to be used for cooperative management of licenses on the basis of business tie-up when a contents sale site 100 having the contents management device 110 and a contents archive site 160 having the contents storage device 130 are business sites independent of each other.

The contents storage device 130 stores contents purchased by users and stores contents requested to be downloaded by users.

The contents synchronization device 140 collects contents from the contents management device 110 and performs batch contents download to a terminal unit 150 when a user wants to download selected contents by batch processing. On this occasion, the contents synchronization device 140 cooperates with the terminal unit 150 to monitor whether all the contents selected by the user are downloaded or not.

The terminal unit 150 (user terminal) is a terminal used by each user. Examples of the terminal unit 150 include all apparatuses each of which can serve as a terminal unit, such as a personal computer (PC), a personal digital assistant (PDA), a tablet PC, etc. The terminal unit 150 can be also used in an off-line mode.

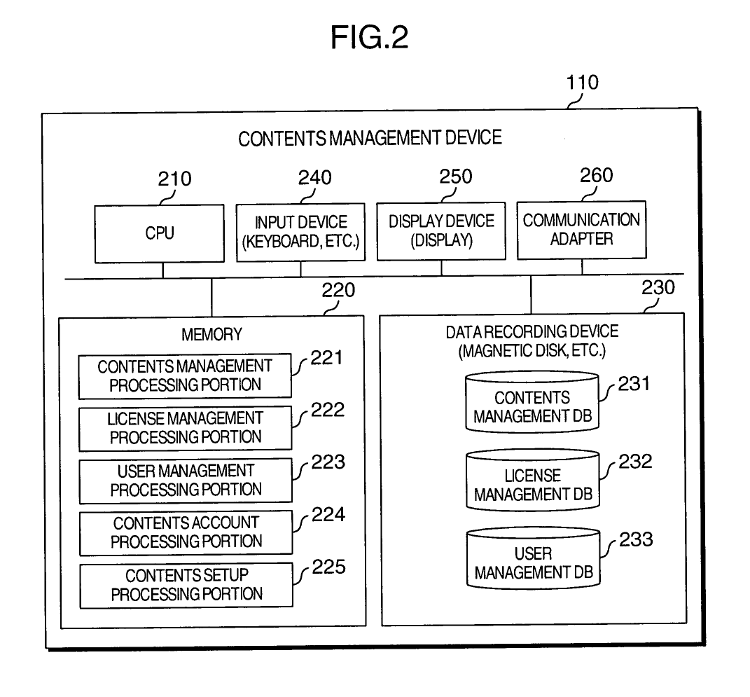

FIG. 2 is a diagram showing the configuration of the contents management device 110 depicted in FIG. 1. As shown in FIG. 2, the contents management device 110 has a CPU 210, a memory 220, a data recording device 230, an input device 240 (such as a keyboard), a display 250 as a display device, and a communication adapter 260.

The CPU 210 is a controller for controlling the operation of the contents management device 110 as a whole. The memory 220 is a recoding device loaded with data and various kinds of processing programs for controlling the operation of the contents management device 110. The data recording device 230 is a recording device for storing the various kinds of processing programs and various kinds of digital contents. The input device 240 (such as a keyboard) is an input device for inputting operation instructions or the like to the contents management device 110. The communication adapter 260 is an adapter for communication with other devices.

The memory 220 in the contents management device 110 has a contents management processing portion 221, a license management processing portion 222, a user management processing portion 223, a contents account processing portion 224, and a contents setup processing portion 225.

The contents management processing portion 221 performs sale processing at the time of selling contents to a user, collection processing at the time of user's issuing a request to collect contents from the user, and purchase processing at the time of user's issuing a request to purchase contents from the user and stores processing results in a contents management DB 231. The license management processing portion 222 performs processing for granting licenses for contents respectively and processing for deleting a license from a user's contents list at the time of collection/purchase of the license. The license management processing portion 222 stores processing results in a license management DB 232.

The user management processing portion 223 manages incentive points etc. as well as information concerning sale to users, and collection and purchase from users, and exchanges data with a user management DB 233. The contents account processing portion 224 performs account processing at the time of sale of contents and is linked to an external settlement system. The contents setup processing portion 225 performs processing for setting up contents in the contents storage device 130 so that contents purchased by the user can be downloaded at any time.

The contents management DB 231 in the data recording device 230 manages information concerning sale, collection and purchase of contents processed by the contents management processing portion 221. The license management DB 232 manages contents license information processed by the license management processing portion 222. The user management DB 233 manages information concerning contents sale for each individual user (as a history of sale to the user and purchase from the user) processed by the user management processing portion 223.

A program for making the contents management device 110 function as each of the contents management processing portion 221, the license management processing portion 222, the user management processing portion 223, the contents account processing portion 224 and the contents setup processing portion 225 is recorded in a recording medium such as a CD-ROM, stored in the recording device such as a magnetic disk and then loaded into the memory so that the program can be executed. Incidentally, the medium used for recording the program may be another recording medium such as a DVD or a DAT than the CD-ROM.

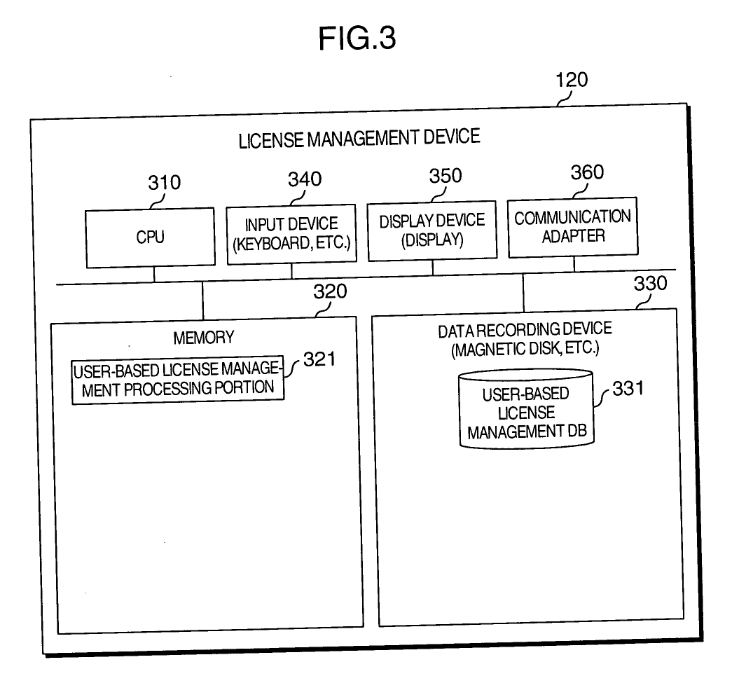

FIG. 3 is a diagram showing the configuration of the license management device 120 depicted in FIG. 1. As shown in FIG. 3, the license management device 120 has a CPU 310, a memory 320, a data recording device 330, an input device 340 such as a keyboard, a display 350, and a communication adapter 360.

The CPU 310 is a controller for controlling the operation of the license management device 120 as a whole. The memory 320 is a recording device loaded with data and various kinds of processing programs for controlling the operation of the license management device 120. The data recording device 330 is a recording device for storing the various kinds of processing programs and various kinds of digital contents. The input device 340 is an input device for inputting operation instructions or the like to the license management device 120. The communication adapter 360 is an adapter for communication with other devices.

The memory 320 in the license management device 120 has a user-based license management processing portion 321. The user-based license management processing portion 321 manages a list of contents held by each user and licenses of the contents in a user-based license management DB 331. When the contents storage device 130 requests the user-based license management processing portion 321 to collate contents in accordance with each user, the user-based license management processing portion 321 performs processing for retrieving contents in accordance with each user from the user-based license management DB 331 and replying to the contents storage device 130 by the license result.

The user-based license management DB 331 in the data recording device 330 manages contents license information in accordance with each user.

A program for making the license management device 120 function as the user-based license management processing portion 321 is recorded in a recording medium such as a CD-ROM, stored in the recording device such as a magnetic disk and then loaded into the memory so that the program can be executed. Incidentally, the medium used for recording the program may be another recording medium such as a DVD or a DAT than the CD-ROM.

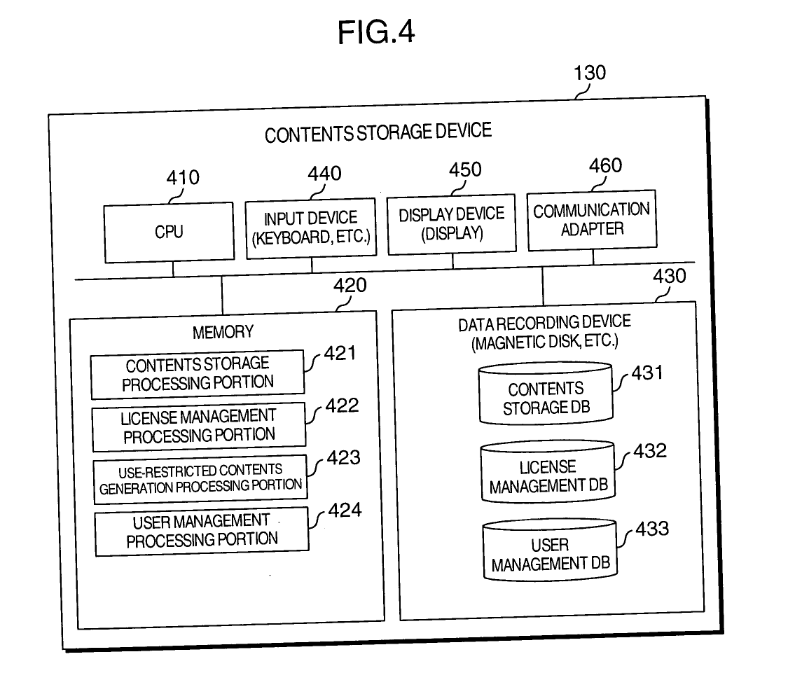

FIG. 4 is a diagram showing the configuration of the contents storage device 130 depicted in FIG. 1. As shown in FIG. 4, the contents storage device 130 has a CPU 410, a memory 420, a data recording device 430, an input device 440 such as a keyboard, a display 450, and a communication adapter 460.

The CPU 410 is a controller for controlling the operation of the contents storage device 130 as a whole. The memory 420 is a recording device loaded with data and various kinds of processing programs for controlling the operation of the contents storage device 130. The data recording device 430 is a recording device for storing the various kinds of processing programs and various kinds of digital contents. The input device 440 is an input device for inputting operation instructions or the like to the contents storage device 130. The communication adapter 460 is an adapter for communication with other devices.

The memory 420 in the contents storage device 130 has a contents storage processing portion 421, a license management processing portion 422, a use-restricted contents generation processing portion 423, and a user management processing portion 424.

The contents storage processing portion 421 performs processing in accordance with a contents setup request or a contents deletion request given from the contents management device 110 in accordance with each user. The contents storage processing portion 421 performs processing so that contents sent from the contents management device 110 in accordance with each user are stored in a contents storage DB 431 in the data recording device 430. Similarly, license information and user information of contents sent from the contents management device 110 are managed by a license management DB 432 and a user management DB 433 respectively in the data recording device 430.

The license management processing portion 422 manages licenses of contents processed by the contents storage processing portion 421. The license management processing portion 422 collates licenses for the license management device 120 in accordance with each user and sends collation results to the contents storage processing portion 421.

The use-restricted contents generation processing portion 423 acquires contents held by a user from the contents storage DB 431 and generates restricted contents with an audiovisual and playback time limit when the contents storage processing portion 421 receives a download request from the user.

The user management processing portion 424 manages owners (users) of contents managed in the contents storage device 130 and processes information concerning user individuals such as user customization information, user private information so that these pieces of information are managed in the user management DB 433. The user management processing portion 424 performs processing such as user authentication by using these pieces of information. The user management processing portion 424 identifies each user and contents held by the user by using the user ID of the user and the contents ID of the contents.

The contents storage DB 431 manages contents in accordance with each user and attribute information of the contents. These pieces of information are sent to the use-restricted contents generation processing portion 423 and finally sent to the terminal unit 150 in accordance with an instruction given from the contents storage processing portion 421.

A program for making the contents storage device 130 function as each of the contents storage processing portion 421, the license management processing portion 422, the use-restricted contents generation processing portion 423 and the user management processing portion 424 is recorded in a recording medium such as a CD-ROM, stored in the recording device such as a magnetic disk and then loaded into the memory so that the program can be executed. Incidentally, the medium used for recording the program may be another recording medium such as a DVD or a DAT than the CD-ROM.

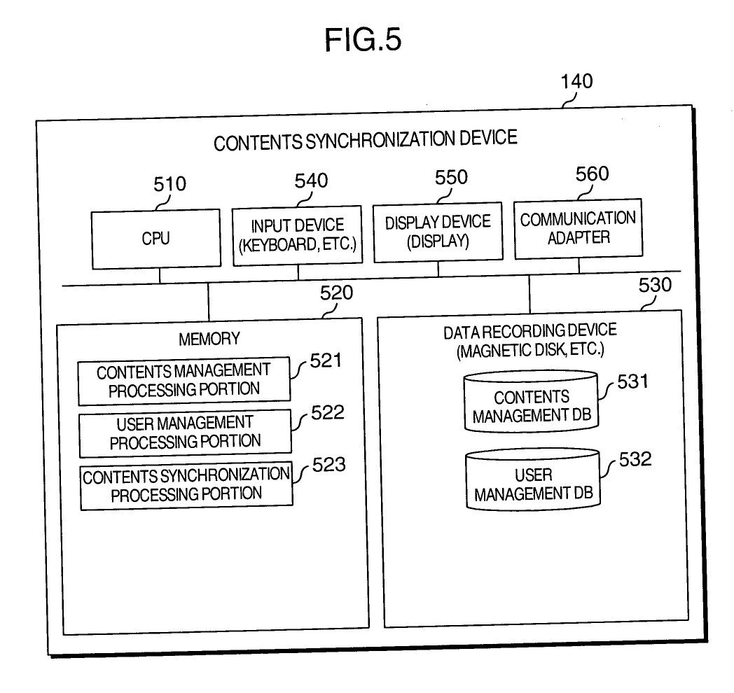

FIG. 5 is a diagram showing the configuration of the contents synchronization device 140 depicted in FIG. 1. As shown in FIG. 5, the contents synchronization device 140 has a CPU 510, a memory 520, a data recording device 530, an input device 540, a display 550, and a communication adapter 560.

The CPU 510 is a controller for controlling the operation of the contents synchronization device 140 as a whole. The memory 520 is a recording device loaded with data and various kinds of processing programs for controlling the operation of the contents synchronization device 140. The data recording device 530 is a recording device for storing the various kinds of processing programs and various kinds of digital contents. The input device 540 is an input device for inputting operation instructions or the like to the contents synchronization device 140. The communication adapter 560 is an adapter for communication with other devices.

The memory 520 in the contents synchronization device 140 has a contents management processing portion 521, a user management processing portion 522, and a contents synchronization processing portion 523.

The contents management processing portion 521 selects contents to be batch-downloaded to the terminal unit 150 from contents held by each user and acquires the contents from the contents storage device 130 to make preparations for download of the contents to the user's terminal unit 150.

The user management processing portion 522 manages customization information such as a list of contents to be synchronized in accordance with each user and private information. The private information is stored as user management information in a user management DB 532.

The contents synchronization processing portion 523 performs processing so that all the contents prepared by the contents management processing portion 521 are sent to the terminal unit 150 while the contents list selected by the user and managed in the contents synchronization device 140 is synchronized with a contents list managed in the terminal unit 150.

A program for making the contents synchronization device 140 function as each of the contents management processing portion 521, the user management processing portion 522 and the contents synchronization processing portion 523 is recorded in a recording medium such as a CD-ROM, stored in the recording device such as a magnetic disk and then loaded into the memory so that the program can be executed. Incidentally, the medium used for recording the program may be another recording medium such as a DVD or a DAT than the CD-ROM.

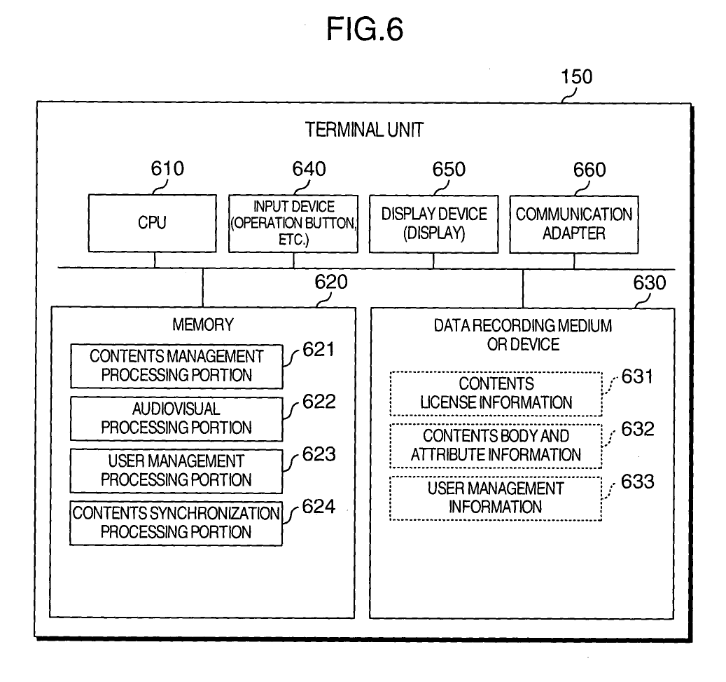

FIG. 6 is a diagram showing the configuration of the terminal unit 150 depicted in FIG. 1. As shown in FIG. 6, the terminal unit 150 has a CPU 610, a memory 620, a data recording medium or data recording device 630 such as a hard disk, an input device 640 such as an operation button, a display device 650 such as a display, and a communication adapter 660.

The CPU 610 is a controller for controlling the operation of the terminal unit 150 as a whole. The memory 620 is a recording device loaded with data and various kinds of processing programs for controlling the operation of the terminal unit 150. The data recording device 630 is a recording device for storing the various kinds of processing programs and various kinds of digital contents. The input device 640 is an input device for inputting operation instructions or the like to the terminal unit 150. The communication adapter 660 is an adapter for communication with other devices.

The memory 620 in the terminal unit 150 has a contents management processing portion 621, an audiovisual processing portion 622, a user management processing portion 623, and a contents synchronization processing portion 624.

The contents management processing portion 621 acquires contents from the contents storage device 130 and stores contents license information 631 and contents body and attribute information 632 in the data recording device 630. The audiovisual processing portion 622 performs processing for displaying user management information 633 and the contents body and attribute information 632 stored in the data recording medium or device 630 of the terminal unit 150 on the display 650 and also performs processing for displaying user operation results in the terminal unit 150 such as display of a setting screen on the display 650.

The user management processing portion 623 manages customization information such as a contents display method and private information in the terminal unit 150. The private information is stored as user management information 633 in the data recording device 630. The contents synchronization processing portion 624 acquires contents from the contents synchronization device 140 by batch processing and stores the contents license information 631 and the contents body and attribute information 632 in the data recording medium or device 630.

A program for making the terminal unit 150 function as each of the contents management processing portion 621, the audiovisual processing portion 622, the user management processing portion 623 and the contents synchronization processing portion 624 is recorded in a recording medium such as a CD-ROM, stored in the recording device such as a magnetic disk and then loaded into the memory so that the program can be executed. Incidentally, the medium used for recording the program may be another recording medium such as a DVD or a DAT than the CD-ROM.

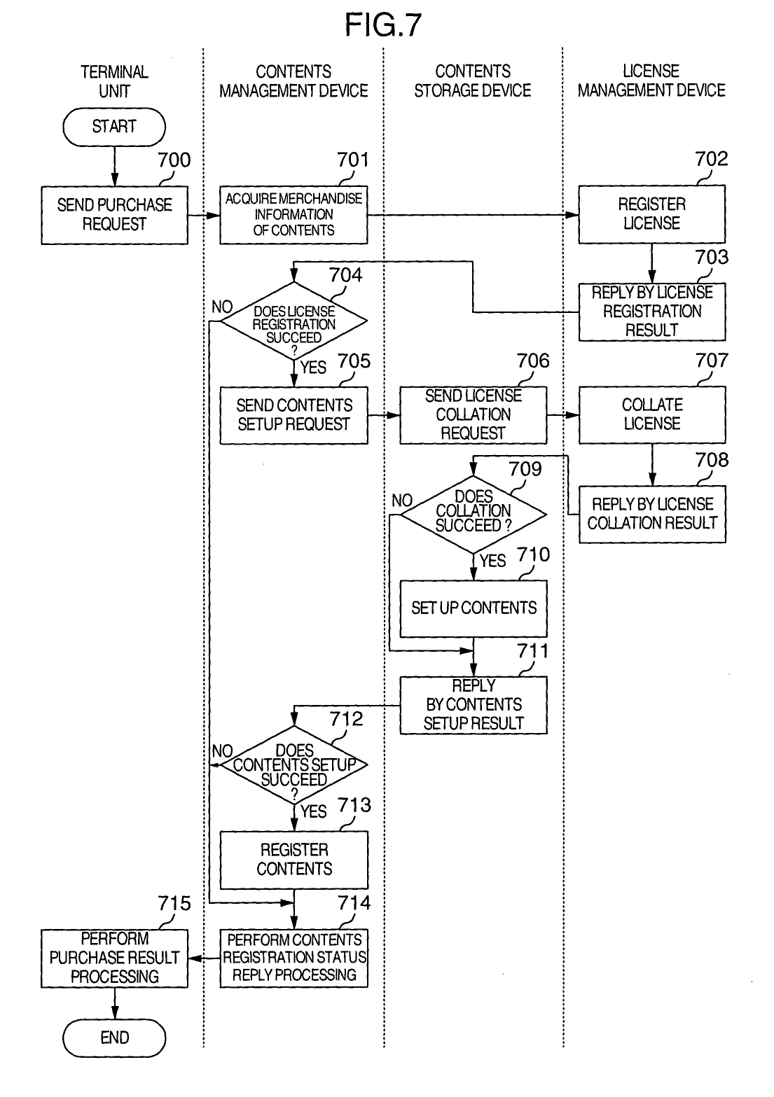

FIG. 7 is a flow chart showing a processing procedure in a method for setting up contents in the contents storage device 130 at the time of user's purchase of contents in the system having the contents management device 110, the license management device 120, the contents storage device 130 and the terminal units 150 according to this embodiment.

First, the contents management processing portion 621 of each terminal unit 150 sends a contents purchase request to the contents management device 110 (step 700). Contents designated by the request are specified on the basis of contents identification information. The contents management processing portion 221 of the contents management device 110 acquires merchandise information of the contents from merchandise management table data 1300 by using the contents identification information sent in the step 700 (step 701). The acquired merchandise information includes selling prices, etc. In the step 701, an account processing request is given to the contents account processing portion 224 in concurrence with the processing for acquiring merchandise information of the contents. Unless the contents account processing portion 224 completes the contents account processing for the user wanting to purchase the contents, the current position of the procedure does not go to the next step. When the contents account processing succeeds, the current position of the procedure goes to step 702. Incidentally, whether cash account or credit account is used can be decided according to a business method of each businessman.

Then, the license management device 120 performs processing for registering the license of the contents requested by the contents management device 110 (step 702). That is, in the step 702, the license management device 120 acquires numbers such as a user ID and a contents ID from the contents management device 110 and registers the license of the contents requested to be purchased in the step 701, in the user-based license management DB 331 of the license management device 120. The result of the license registration processing in the step 702 is sent to the contents management device 110 (step 703). On this occasion, the license is registered if the registration processing succeeds, but the license is not registered if the registration processing fails.

Then, the contents management device 110 makes a judgment on the basis of the license registration result as reply processing in the step 703 as to whether the license registration succeeds or not (step 704). When the license registration succeeds, the contents management device 110 gives a contents setup request to the contents storage device 130 (step 705). On the other hand, when the license registration fails, the contents are not registered and a notice of the failure in the license registration is sent to the terminal unit (step 714).

Then, the contents storage device 130 requests the license management device 120 to collate the license as to whether the user purchasing the contents is licensed to use the contents requested to be set up by the contents management device 110 or not (step 706). The license management device 120 collates the license in accordance with the license collation request (step 707) and replies by the collation result to the contents storage device 130 (step 708).

Then, the contents storage device 130 makes a judgment on the basis of the collation result sent back from the license management device 120 as to whether collation succeeds or not, that is, whether the user purchasing the contents is licensed to use the contents requested to be set up or not (step 709). When collation succeeds, contents setup processing is performed (step 710). When collation fails, information indicating the failure in collation and incompletion of the contents setup processing is sent back to the contents management device 110 (step 711). Although the current position of the procedure goes to the step 711 regardless of whether collation succeeds or not, information sent back to the contents management device 110 in the step 711 varies according to the collation result.

The contents management device 110 makes a judgment on the basis of the contents setup result sent back from the contents storage device 130 as to whether the contents are set up or not (step 712). When the contents are set up, the contents management device 110 registers the contents (step 713). If a decision is made in the step 712 that the contents are not registered, it is necessary to invalidate the account processing carried out in the step 701. Accordingly, not use of cash account processing but use of credit account processing in the step 701 is efficient.

Then, the contents management device 110 sends a registration status indicating whether the contents are registered or not, back to the terminal unit 150. The terminal unit 150 performs contents purchase result processing on the basis of the result sent back (step 715).

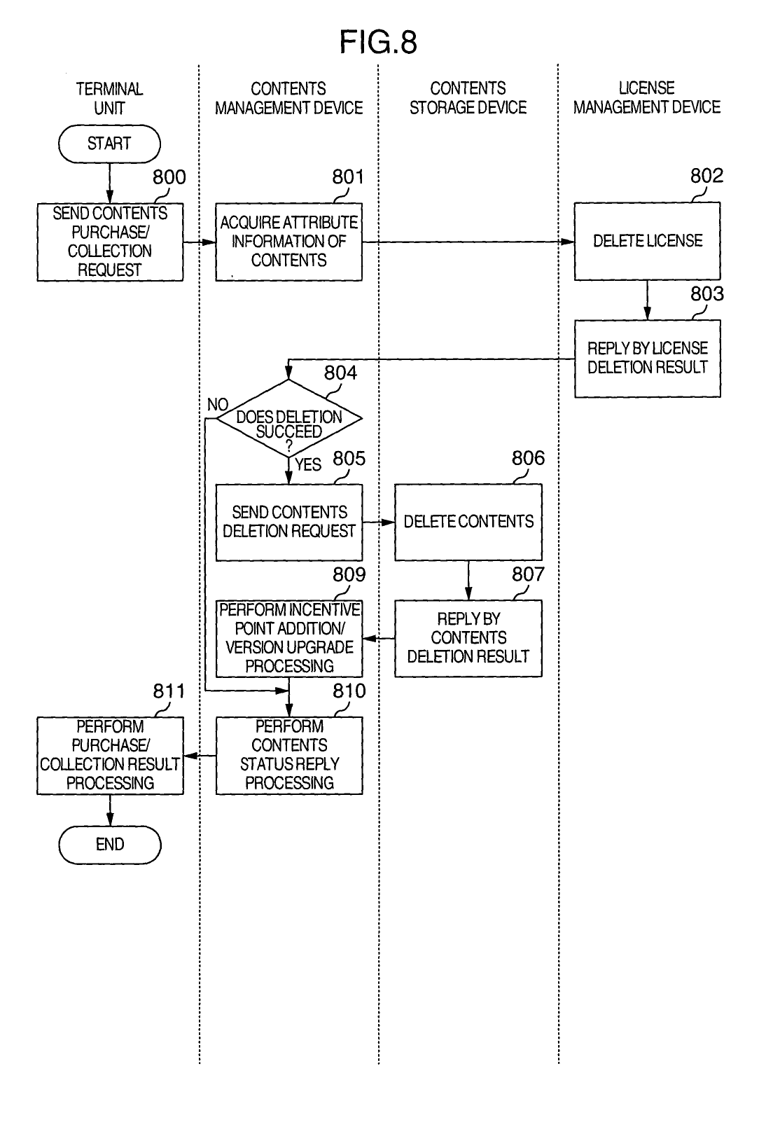

FIG. 8 is a flow chart showing a procedure in contents deletion processing of the contents storage device 130 at the time of collection or purchase of contents from a user, in the system having the contents management device 110, the license management device 120, the contents storage device 130 and the terminal units 150.

First, the contents management processing portion 621 of each terminal unit 150 sends a request of purchase/collection of contents held by the user, to the contents management processing portion 221 of the contents management device 110 (step 800). The contents are specified on the basis of contents identification information. Then, the contents management processing portion 221 of the contents management device 110 acquires attribute information of contents held by the user from the contents management DB 231 and the license management DB 232 by using the contents identification information sent from the terminal unit 150 in the step 800 (step 801). When the user and the contents are verified, the current position of the procedure goes to step 802.

Then, the license management device 120 performs license deletion processing for the contents requested by the contents management device 110 (step 802). That is, on this occasion, the license management device 120 acquires numbers such as a user ID and a contents ID from the contents management device 110 and deletes the license of the contents from the user-based license management DB 331 of the license management device 120. The result of the deletion processing is sent back to the contents management device 110 (step 803). The contents management device 110 makes a judgment on the basis of the sent deletion result as to whether the deletion processing succeeds or not (step 804). When the license deletion processing succeeds, the contents management device 110 sends a contents deletion request to the contents storage device 130 (step 805). When the license deletion processing fails, the license is not deleted but a contents status indicating the failure in the deletion processing is sent back to the terminal unit 150 (step 810).

When a decision is made in the step 804 that the license deletion processing succeeds, the contents management device 110 requests the contents storage device 130 to delete contents corresponding to the license deleted by the license management device 120 (step 805). The contents storage processing portion 421 of the contents storage device 130 deletes the contents in accordance with the contents deletion request received (step 806). When the contents deletion processing fails, the deletion processing is repeated by a predetermined number of times. This is because repetition of the deletion processing till success causes instability of the system.

The contents storage device 130 sends a result of the contents deletion processing in the step 806 back to the contents management device 110 (step 807).

The contents management device 110 performs incentive point addition/contents version upgrade processing for the user issuing the contents purchase/collection request, on the basis of the result sent back from the contents storage device 130 (step 809). On this occasion, when the license deletion fails, incentive point addition processing is not performed. Incidentally, the incentive points may be given to the user so that the user can purchase digital contents for the added incentive points but the digital contents purchased for the incentive points cannot be sold but can be collected from the user. The contents version upgrade processing is a processing in which the version of contents can be upgraded at a special price lower than the ordinary price.

Then, the contents management device 110 sends a current contents status back to the terminal unit 150 (step 810). The terminal unit 150 performs processing for displaying the result of collection/purchase of the contents requested by the user and storing information concerning collection/purchase of the contents on the basis of the result sent back (step 811).

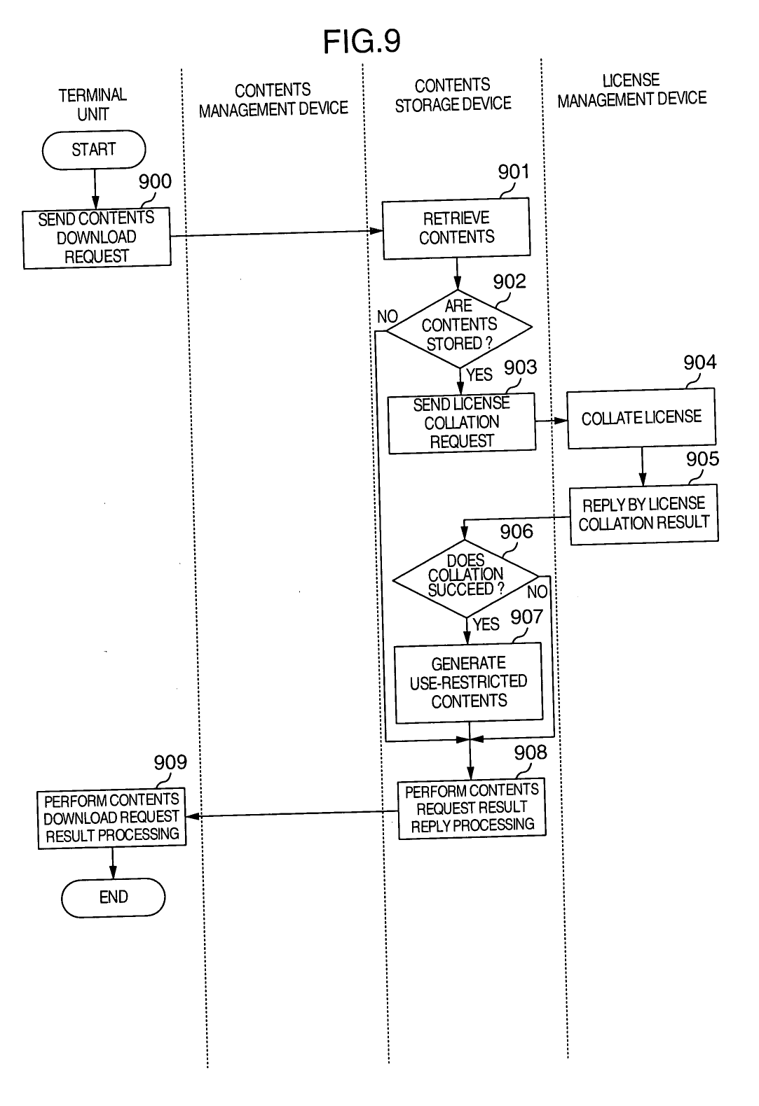

FIG. 9 is a flow chart showing a processing procedure in an individual contents download method used in the system having the license management device 120, the contents storage device 130 and the terminal units 150.

First, the contents management processing portion 621 of each terminal unit 150 sends a request to the contents storage device 130 to download contents from the contents storage device 130 (step 900). Then, the contents storage processing portion 421 of the contents storage device 130 retrieves the designated contents stored in the contents storage DB 431 of the contents storage device 130 on the basis of contents identification information sent in the step 900 (step 901) and judges whether the contents are stored in the contents storage DB 431 of the contents storage device or not (step 902).

When a decision is made that the contents are stored in the contents storage DB 431, the contents storage device 130 sends a request to the license management device 120 to collate the license (step 903). Incidentally, license collation in the step 903 may be performed in the contents storage device 130 if the contents storage device 130 can perform the same processing as the license management device 120.

The license management device 120 collates the license in accordance with the license collation request issued in the step 903 (step 904). A result of collation is sent back to the contents storage device 130 (step 905).

The contents storage device 130 makes a judgment on the basis of the license collation result sent back from the license management device 120 as to whether collation succeeds or not (step 906). When collation succeeds, the use-restricted contents generation processing portion 423 of the contents storage device 130 generates use-restricted contents (step 907). When collation fails, information indicating failure in collation and incompletion of contents setup is sent back to the terminal unit 150 (step 908). Although the current position of the procedure goes to the step 908 regardless of whether collation succeeds or not, information sent back to the terminal unit 150 varies according to the collation result. Then, the terminal unit 150 performs processing for displaying the result of the contents download request and storing the result (step 909).

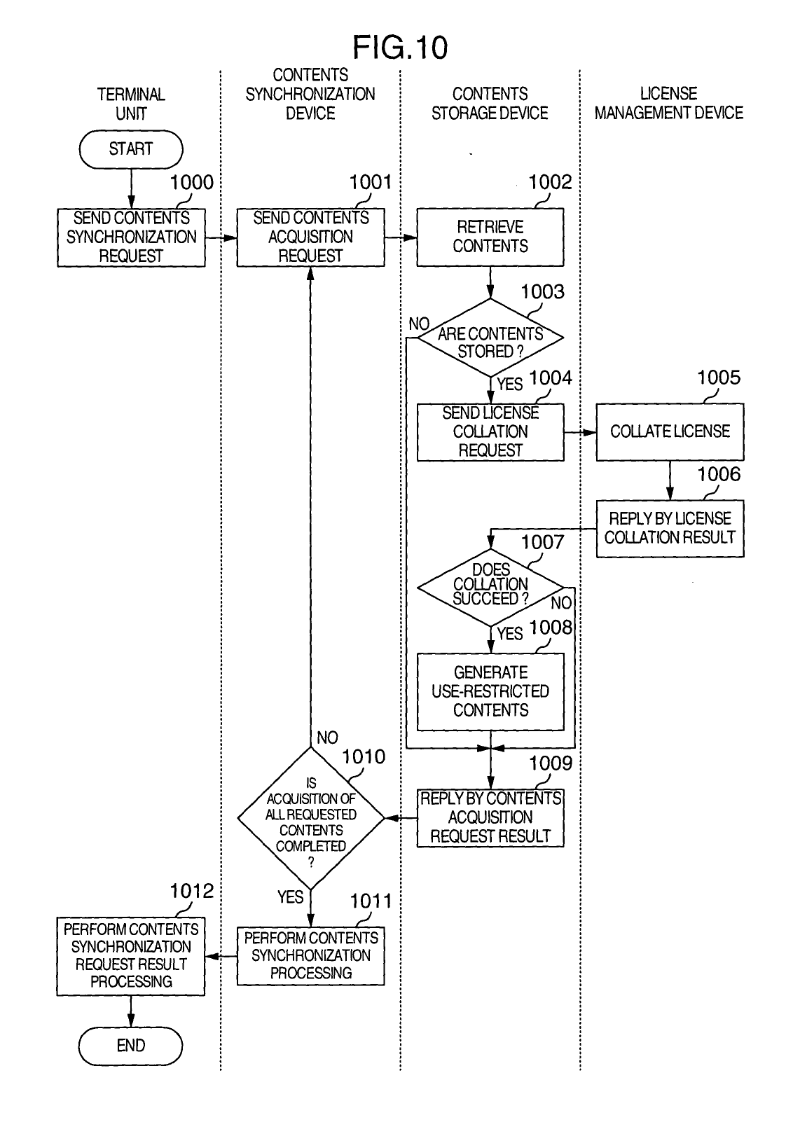

FIG. 10 is a flow chart showing a processing procedure in a batch contents download method used in the system having the contents management device 110, the license management device 120, the contents synchronization device 140 and the terminal units 150.

The contents management processing portion 621 of each terminal unit 150 sends a request to the contents synchronization device 140 to download contents by batch processing (step 1000). Incidentally, the contents to be downloaded by batch processing are selected by the user and specified by the contents synchronization device 140 before the batch download processing. The term “synchronization” means the user's action made to the contents synchronization device 140, in which action the user selects contents to be downloaded to the terminal unit 150 so that the latest contents (e.g., news contents or latest reports) can be downloaded when batch download is required.

Then, the contents synchronization device 140 sends an acquisition request to the contents storage device 130 to acquire contents not cached in the contents synchronization device 140 from the contents list selected by the user in advance (step 1001). In the step 1001, the contents are specified on the basis of the contents identification information.

Then, the contents storage processing portion 421 of the contents storage device 130 retrieves the designated contents stored in the contents storage DB 431 of the contents storage device 130 on the basis of the contents identification information sent in the step 1001 (step 1002) and judges whether the contents are stored or not (step 1003). When the contents are stored in the contents storage DB 431, the contents storage device 130 sends a license collation request to the license management device 120 to check whether the contents are licensed or not (step 1004). Incidentally, license collation may be performed in the contents storage device 130 if the contents storage device 130 can perform the same processing as the license management device 120.

The license management device 120 collates the license in accordance with the license collation request sent from the contents storage device 130 (step 1005). A result of license collation is sent back to the contents storage device 130 (step 1006).

The contents storage device 130 makes a judgment on the basis of the information of the license collation result sent back from the license management device 120 as to whether license collation succeeds or not (step 1007). When license collation succeeds, the use-restricted contents generation processing portion 423 of the contents storage device 130 generates use-restricted contents (step 1008). When license collation fails, information indicating failure in collation and incompletion of contents generation is sent back to the contents synchronization device 140 (step 1009). Although the current position of the procedure goes to the step 1009 regardless of whether collation succeeds or not, information sent back to the contents synchronization device 140 varies according to the collation result.

When the contents requested by the user are generated in the step 1008, a result indicating completion of generation of the requested contents is generated and sent back to the contents synchronization device 140 (step 1009). The contents synchronization device 140 judges whether all the contents requested by the user have been already acquired or not (step 1010). When all the contents have been not acquired yet, the current position of the procedure goes back to the contents acquisition request processing (step 1001) to acquire remaining contents. On the other hand, when all the requested contents have been already acquired, the contents synchronization device 140 performs contents synchronization processing (step 1011). In the step 1011, batch contents download is performed while the contents synchronization processing portion 523 of the contents synchronization device 140 cooperates with the contents synchronization processing portion 624 of the terminal unit 150 to intend data synchronization.

Finally, the terminal unit 150 checks whether all the contents requested by the user have been already downloaded (i.e., synchronization processing has been already performed) or not (step 1012).

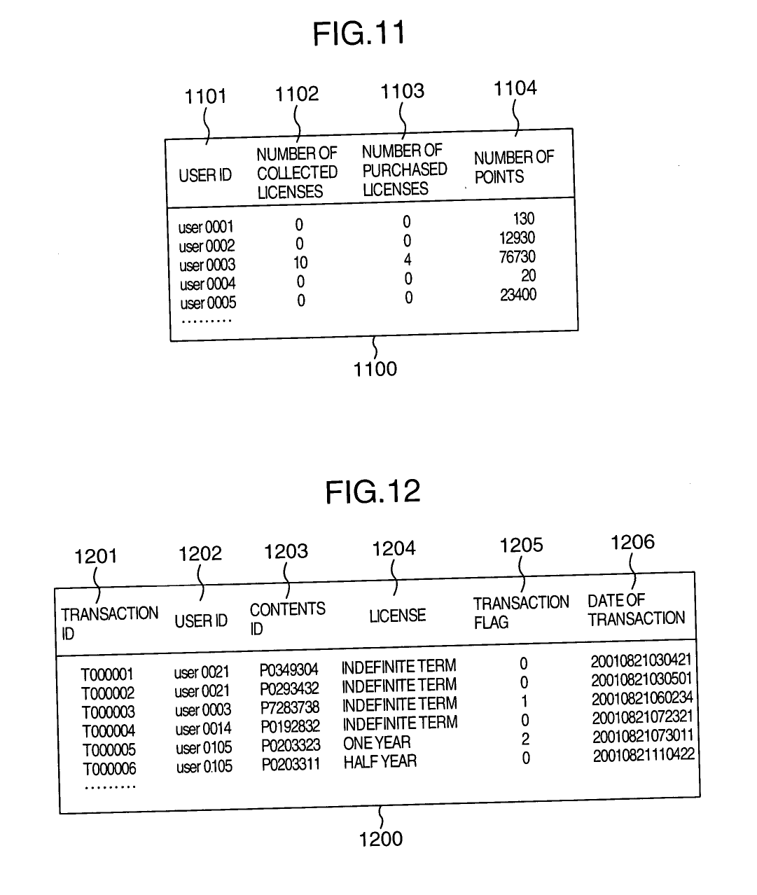

FIG. 11 is a view showing a user-based license transfer management table which is a data table for managing the number of licenses collected from each user, the number of licenses purchased from each user and the number of incentive points given to each user and which is stored in the user-based license management DB 331 in this embodiment. The user-based license transfer management table 1100 has, as data items, user ID 1101, number of collected licenses 1102, number of purchased licenses 1103, and number of incentive points 1104.

The user ID 1101 is a number unique in this system for identifying each user. The number of collected licenses 1102 and the number of purchased licenses 1103 are accounted numbers of licenses collected and purchased by the contents management device 110 from each user. The number of incentive points 1140 is a number of points added when each user returns licenses without paying any fee (i.e., the contents management device 110 collects licenses from each user) or when each user sells licenses (i.e., the contents management device 110 purchases licenses from each user). Further, each user can purchase new contents or upgrade the version of contents by using the incentive points.

FIG. 12 is a view showing a transaction management table which is provided for managing processing concerning sale, collection and purchase of contents and which is stored in the license management DB 432 of the contents storage device 130. The transaction management table 1200 has, as data items, transaction ID 1201, user ID 1202, contents ID 1203, license type 1204, transaction flag 1205, and date of transaction 1206.

The transaction ID 1201 is a number unique in this system for identifying each transaction in the transaction management table. The user ID 1202 is a number for identifying each user. The contents ID 1203 is a number for identifying contents. The user ID 1202 and the contents ID 1203 as well as the transaction ID 1201 are numbers unique in this system. The license type 1204 indicates the license type of contents. For example, the license type 1204 indicates the audiovisual/playback term such as an indefinite term, a half year, etc. The transaction flag 1205 indicates which of license collection, license purchase and use of points was performed as each transaction. When the flag has a value of zero, the flag indicates that the transaction performed was ordinary sale. When the flag has a value of 1, the flag indicates that the transaction performed was collection. When the flag has a value of 2, the flag indicates that the transaction was purchase. When the flag has a value of 3, the flag indicates that the transaction was use of points. The date of transaction 1206 indicates the date when the transaction was performed.

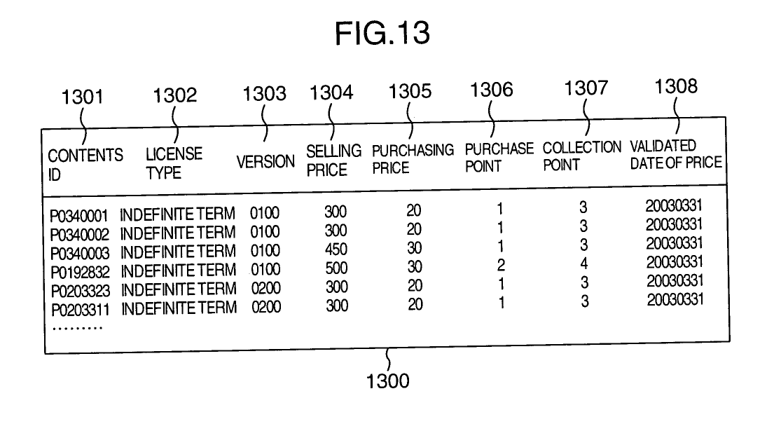

FIG. 13 is a view showing a merchandise management table indicating licenses of contents and selling prices of the licenses.

The merchandise management table 1300 is stored in the contents storage DB 431 of the contents storage device 130. The merchandise management table 1300 has, as data items, contents ID 1301, license type 1302, version 1303, selling price 1304, purchasing price 1305, purchase point 1306, collection point 1307, and validated date of price 1308.

The contents ID 130 is a number for identifying contents to be sold. Each user selects the contents ID and trades contents. The license type 1302 indicates the license type of contents. For example, the license type 1302 indicates a audiovisual/playback term such as an indefinite term, a half year, etc. The version 1303 indicates the version of contents. The selling price 1304 indicates a price used for selling contents. The purchasing price 1305 indicates a price for purchasing contents from each user. In collection of contents from each user, incentive points called collection point 1307 are prepared in consideration of the user's benefit because contents are received from the user without a fee. The validated date of price 1308 indicates the validated date of the selling price 1304 and the purchasing price 1305. The validated date of price 1308 may be used as the validated date of the purchase point 1306 and the collection point 1307.

As described above, in the digital contents license and incentive point management system according to this embodiment, licenses of digital contents can be recycled because digital contents license sale is performed in such a manner that unnecessary one of licenses of contents available on the market is collected or purchased from each user and incentive such as issuing of new licenses or addition of points is given to the user as an owner of the license on the basis of user information, contents information, or the like, picked up from the license.

In addition, user's convenience can be improved because licenses (rights of audiovisual display/playback) of sold digital contents can be collected or purchased from each user and because other digital contents or upgraded version digital contents can be sold at special prices to the user or incentive points can be given to the user. Accordingly, unnecessary digital contents on digital contents distributing business can be recycled.

Incidentally, digital contents licensed up to the expiration date for use must be originally kept at hand of the user purchasing the digital contents. It may be however hardly said that audiovisual display/playback of digital contents with only one of diversified apparatuses large in number is convenient to the user. To improve user's convenience, it is necessary that digital contents can be downloaded anywhere at any time for audiovisual display/playback if the apparatus used has been already registered and can be connected to a network. This can be achieved when the license and the body of digital contents are managed by a contents management system (contents management server) on the network. The user having rights of audiovisual display of digital contents can download the digital contents in an expiration date-set state for use of audiovisual display/playback as occasion demands. This is generally called network archive service of digital contents (see the contents archive service site in FIG. 1).

The point of difference of the network archive service used in the invention from the ordinary archive service is that the expiration date for use of audiovisual display/playback is set in the downloaded digital contents. Because the expiration date for use of audiovisual display/playback is set, audiovisual display/playback can be disabled when a predetermined term has passed after download of the contents to a plurality of apparatuses. This makes it possible to download digital contents to a plurality of apparatuses possessed by each user and collect or purchase the licenses of the digital contents from each user. Because digital contents can be downloaded for audiovisual display/playback at any time when audiovisual display/playback is required, user's convenience is not worsened.

The user using the network archive service has the following convenience. Even in the case where an apparatus possessed by the user breaks down, there is no fear that digital contents purchased by the user may vanish because the purchased digital contents are present on the site. Accordingly, the digital contents purchased by the user can be accessed and downloaded by the user at any time safely.

A personal digital assistant (PDA) may be one of apparatuses possessed by the user. It cannot be said that the data storage capacity of the PDA is large compared with that of a general PC. The way of downloading digital contents necessary for audiovisual display/playback as occasion demands is convenient to the user.

According to the invention, in digital contents license sale, licenses available on the market can be collected or purchased from each user, so that licenses of digital contents can be recycled.

It should be further understood by those skilled in the art that although the foregoing description has been made on embodiments of the invention, the invention is not limited thereto and various changes and modifications may be made without departing from the spirit of the invention and the scope of the appended claims.

1. A digital contents license and privilege management method for managing licenses and privileges granted for digital contents to users, comprising the steps of:
registering licenses for digital contents requested to be purchased by each user;
registering association of said registered licenses with each user in a database;
storing the digital contents having said registered licenses and information concerning said licenses;
deleting a license corresponding to a license return request from said database when receiving the license return request to return a license granted for digital contents selected from said stored digital contents by a user;
specifying a user corresponding to said deleted license; and
performing management while associating said specified user with contents of said deleted license or with a privilege corresponding to said license return request.

2. A digital contents license and privilege management method according to claim 1, further comprising the steps of:
processing said request to return a license granted for digital contents as collection or purchase of said license; and
storing information concerning collection or purchase of said license in said database while associating said information with a user corresponding to said license designated by said license return request.

3. A digital contents license and privilege management method according to claim 2, further comprising the step of storing a privilege corresponding to said license return request while associating said privilege with said information concerning collection or purchase of said license.

4. A digital contents license and privilege management method according to claim 1, wherein said privilege corresponding to said license return request is version upgrade of digital contents corresponding to said deleted license.

5. A digital contents license and privilege management method according to claim 1, wherein said privilege is points that can be used for purchase of digital contents.

6. A digital contents management apparatus for managing information concerning licenses of purchased digital contents, comprising:
a digital contents management database for storing purchase information of said purchased digital contents;
a license management database for storing license information of said purchased digital contents;
a contents management processing portion for acquiring attribute information of digital contents held by a user from said digital contents management database and said license management database on the basis of user identification information of the user sending a license return request when receiving the license return request to return the license granted for digital contents stored in said digital contents management database; and
a license management processing portion for deleting said license information concerning said deleted license from said license management database on the basis of information of completion of the deletion of said license designated by said license return request;
wherein said contents management processing portion performs management so that digital contents corresponding to said deleted license are deleted in accordance with the information of completion of the deletion of said license designated by said license return request, and that an identification number of the user sending said license return request is associated with a privilege granted to the user in accordance with the return of said license.

7. A recording medium for storing a program that can be read by a computer in a digital contents license management system for managing licenses granted for digital contents to users, said program including the steps of:
registering a license for digital contents requested to be purchased by a user;
storing association of said registered license with said user in a database;
storing the digital contents having said license registered and information concerning said license;
deleting a license corresponding to a license return request from said database when receiving the license return request to return a license granted for digital contents designated by a user in said stored digital contents;
specifying a user corresponding to said deleted license; and
performing management while associating said specified user with contents of said deleted license or with a privilege corresponding to said license return request.

8. A digital contents management apparatus according to claim 6, further comprising a user management database for managing identification information of the user, the license corresponding to the user and the privilege granted to the user while associating the identification information, the license and the privilege with one another.

9. A digital contents management apparatus according to claim 6, wherein said privilege is points that can be used for purchase of digital contents.

10. A digital contents management apparatus according to claim 6, wherein said privilege is version upgrade of digital contents.

11. A digital contents license and privilege management system for managing licenses and privileges granted for digital contents to users, comprising:
a contents storage device for storing information for indicating correspondence between a license for digital contents designated by a purchase request and a user obtaining said license and information concerning said license of said digital contents;
a license management device for deleting a license corresponding to a license return request from a database when receiving the license return request to return a license granted for digital contents designated by a user in digital contents stored in said contents storage device; and
a contents management device for performing management so that the user corresponding to the deleted license is associated with contents of said deleted license or with a privilege granted to the user in accordance with said license return request.

12. A digital contents license and privilege management system according to claim 11, wherein:
said license return request to return a license granted for digital contents is for collection or purchase of said license; and
said contents management device stores information concerning collection or purchase of said license while said information is associated with a user corresponding to said license designated by said license return request.

13. A digital contents license and privilege management system according to claim 12, wherein said contents management device stores a privilege corresponding to said license return request while said privilege is associated with said information concerning collection or purchase of said license.

14. A digital contents license and privilege management system according to claim 11, wherein said privilege corresponding to said license return request is version upgrade of digital contents corresponding to said deleted license.

15. A digital contents license and privilege management system according to claim 11, wherein said privilege is points that can be used for purchase of digital contents.

16. A digital contents license and privilege management system according to claim 12, wherein said contents management device stores information concerning collection or purchase of said license on the basis of transaction information of said license stored in said contents storage device.

17. A digital contents license and privilege management system according to claim 12, wherein said contents management device sends information concerning the status of digital contents designated by said license return request and a privilege corresponding to said license return request to an external device.

18. A computer program executed in a digital contents license and privilege management system for managing licenses and privileges granted for digital contents to users, comprising the steps of:
registering correspondence between a license registered for digital contents designated by a purchase request and a user obtaining said license;
storing the digital contents having said license registered and information concerning said license;
deleting a license corresponding to a license return request when receiving the license return request to return a license granted for digital contents designated by a user in said stored digital contents;
specifying a user corresponding to said deleted license; and
performing management while associating said specified user with contents of said deleted license or with a privilege corresponding to said license return request.

19. A computer program according to claim 18, wherein:
said license return request is for collection or purchase of said license; and
said computer program further comprises the step of storing information concerning collection or purchase of said license while associating said information with a user corresponding to said license designated by said license return request.

20. A computer program according to claim 19, further comprising the step of storing a privilege corresponding to said license return request while associating said privilege with said information concerning collection or purchase of said license.
